(19) United States
(12) Patent Application Publication
(10) Pub. No.: US 2007/0229641 A1
(43) Pub. Date: Oct. 4, 2007

(54) Method of cutting recording medium, and post-processing device for recording medium

(75) Inventor: Yusuke Nakazawa, Haibara-gun (JP)

Correspondence Address: SUGHRUE-265550, 2100 PENNSYLVANIA AVE. NW, WASHINGTON, DC, 20037-3213, US

(73) Assignee: FUJIFILM Corporation, Tokyo (JP)

(21) Appl. No.: 11/730,174

(22) Filed: Mar. 29, 2007

(30) Foreign Application Priority Data
Mar. 30, 2006 (JP) 2006-094696

(51) Int. Cl. B41J 2/01

(52) U.S. Cl. 347/104

(57) ABSTRACT

A method of cutting a recording medium for an ink jet device, the ink jet device including: a recording medium conveying unit that conveys a recording medium; and a full-line ink jet head that has substantially the same length as the width of the recording medium, and that ejects an ink toward the recording medium conveyed by the recording medium conveying unit according to image signal to effect recording, which includes: making a mark indicating the longitudinal position of the recording medium from the end head of the full-line ink jet head on the edge of the recording medium; and cutting the recording medium subjected to recording using the marking.

### BACKGROUND OF THE INVENTION

1. Field of the Invention

The present invention relates to a single pass ink jet device having a terminal marking means capable of detecting the image forming position which is not subject to nozzle clogging in single pass ink jet devices in particular and a method of cutting recording medium and post-processing device for recording medium which are effectively performed therewith.

2. Background Art

An ink jet system is advantageous in that a large number of ink jet heads can be easily disposed in no contact with a recording medium, allowing high speed/high quality recording. In recent years, the ink jet system has been applied to many industrial devices. In particular, there has been proposed a so-called single pass ink jet device comprising a head having so great a width as to allow recording all over the width of the recording medium disposed fixed opposed to the recording medium which completes recording when the recording medium passes under the head once. When this single pass ink jet device is used to effect color printing, fixed heads in the number of colors are disposed along the direction of conveyance of the recording medium. In this case, image is scarcely disposed on the portion corresponding to the end of the recording medium. Accordingly, the nozzle of the fixed head for drawing an image on that position ejects an ink less frequently than the nozzle for the other portions. The difference in frequency of ejection between the two nozzles can easily cause the occurrence of defectives such as clogging of the former nozzle, change of amount of ink ejected from the former nozzle and deflection of the direction of ejection from the former ink.

In order to solve these problems, there is disclosed a device which causes the position of the fixed head to move in the width direction of the recording as necessary so that the nozzle at the end can be used (see JP-A-2005-297510 (the term “JP-A” as used herein means an “unexamined published Japanese patent application”)). However, this device is disadvantageous in that the precision position control of the fixed head can be difficultly made, adding to cost.

Further, in order to eliminate nozzle clogging, some related art devices are designed to spit (blank shot) ink from the end head. However, these devices cause ink to be wasted and thus cannot be recommended from the standpoint of resource conservation.

In order to enhance the productivity of this single pass device, on the other hand, the web-shaped recording medium which has been subjected to printing is preferably connected to a post-processing device such as cutting device. To this end, the web-shaped recording medium to be processed needs to be positioned in coincidence with the position of the image thus recorded.

### SUMMARY OF THE INVENTION

The invention has been worked out to solve these problems. An object of the invention is to provide an inexpensive ink jet recording medium post-processing device capable of effecting recording on various recording media at a high productivity without wasting the ink and a convenient cutting method.

(1) According to a first aspect of the present invention, a method of cutting a recording medium for an ink jet device, the ink jet device including: a recording medium conveying unit that conveys a recording medium; and a full-line ink jet head that has substantially the same length as the width of the recording medium, and that ejects an ink toward the recording medium conveyed by the recording medium conveying unit according to image signal to effect recording, which includes: making a mark indicating the longitudinal position of the recording medium from the end head of the full-line ink jet head on the edge of the recording medium; and cutting the recording medium subjected to recording using the marking.

(2) According to a second aspect of the present invention, a post-processing device for a recording medium, the post-processing device including: an ink jet recording device including; a recording medium conveying unit that conveys a recording medium; and a full-line ink jet head that has substantially the same length as the width of the recording medium and that ejects an ink toward the recording medium conveyed by the recording medium conveying unit according to image signal to effect recording; a reading unit that is disposed downstream of the ink jet device along the direction of conveyance of the recording medium, and that reads data recorded on the recording medium by the full-line ink jet head; and a post-processing device that is disposed downstream of the reading unit along the direction of conveyance of the recording medium, and that post-processes the recording medium subjected to recording according to data read by the reading unit, wherein a mark indicating the longitudinal position of the recording medium is regularly made on the edge of the recording medium from the end head of the full-line ink jet head, the reading unit reads the mark and sends result of reading the mark to the post-processing device, and the post-processing device post-processes the recording medium subjected to recording according to positional data read by the reading unit.

(3) The post-processing device for recording medium as described in the item (2), further including: an active energy radiating device that is provided downstream of the full-line ink jet head along the direction of conveyance of the recording medium, and that cures the active energy-curable ink ejected on the recording medium wherein the ink is an active energy-curable ink, and the recording medium is a web-shaped recording medium.

(4) The post-processing device for recording medium as described in the item (3), wherein the web-shaped recording medium comprises an adhesive paper, the adhesive paper comprising: a base material; and a release paper peelably provided on the base material.

(5) The post-processing device for recording medium as described in the item (4), further comprising: a cylinder that makes rocking and rotation; and a punching blade that is attached to many sides of the cylinder and that cuts the release paper of the adhesive paper into a label according to data read by the reading unit.

(6) The post-processing device for recording medium as described in the item (4), further comprising: a stamper that is disposed upward of the adhesive paper during waiting, and that descends toward the adhesive paper during transfer; and a seat unit on which a foil is provided, the seat unit being conveyed between the adhesive paper and the stamper, wherein the stamper presses the seat unit on the adhesive paper to transfer the foil onto one side of the adhesive paper.

In this arrangement, a mark indicating the longitudinal position of the recording medium is regularly made on the edge of the recording medium from the end head of the full-line ink jet head. Using this marking, manual cutting, automatic positioning of punching blade during cutting into label size by a rocking/rotating die cut and determination of automatic timing at which the gold foil transferring device causes the stamper to descend can be made (that is, effective use of marking can be made), making it possible to eliminate ink wasting such as mere “blank shot” of ink from the end head only for the purpose of eliminating nozzle clogging. An inexpensive ink jet recording device having a high productivity capable of recording on various recording media can be obtained.

### BRIEF DESCRIPTION OF THE DRAWINGS

The invention disclosed herein will be understood better with reference to the following drawings of which:

FIG. 1 is a conceptional diagram illustrating an in-line label printing machine as Example 1 of the post-processing device for the ink jet recording medium according to the invention;

FIG. 2 is a longitudinal sectional view illustrating the layer structure of the adhesive paper to be used in the invention;

FIG. 3A is a longitudinal sectional view illustrating the structure of the die cutter for cutting a label recorded by a full-line head and FIG. 3B is a plan view illustrating the label thus recorded;

FIG. 4 is a perspective view of area in the vicinity of the branching roller shown in FIG. 1;

FIG. 5 is a conceptional diagram illustrating an off-line printing system as Example 2 of the invention; and

FIG. 6 is a diagram illustrating a foil pressing device as Example 3 of the post-processing device according to the invention.

### DETAILED DESCRIPTION OF THE INVENTION

### EXAMPLE 1

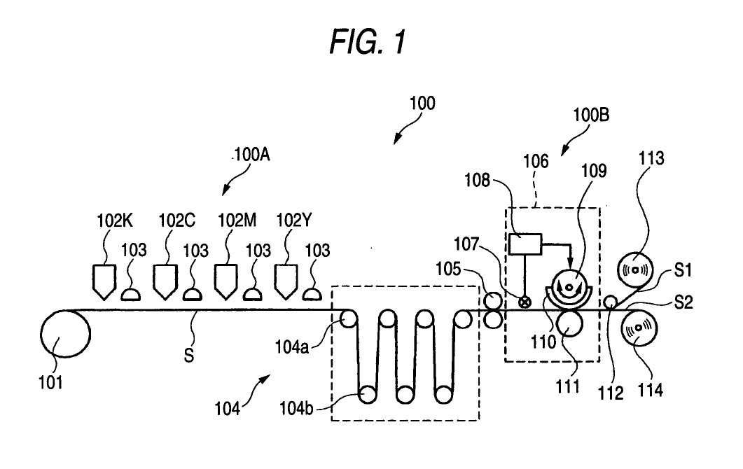

FIG. 1 depicts Example 1 in which the post-processing device for ink jet recording medium of the invention is applied to an in-line label printer. No related art “in-line label printer” exists so far as the present applicant knows.

In FIG. 1, the reference numeral 100 indicates a general external view of an in-line label printer according to the invention, the reference numeral 100A indicates an ink jet recording portion, and the reference numeral 100B indicates a die cutting portion as a post-processing device. A buffer 104 is provided as a buffering portion between the ink jet recording portion 100A and the die cutting portion 100B.

The reference numeral 101 is an adhesive paper S (hereinafter referred to as “recording medium”) wound in a roll. The adhesive paper to be used in the inventive examples will be described hereinafter.

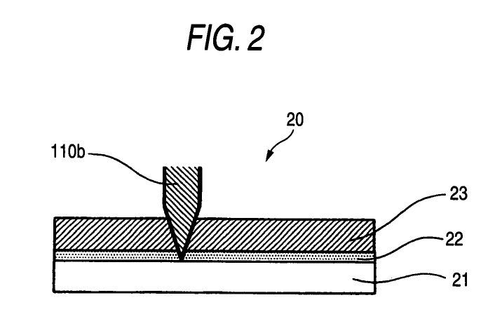

FIG. 2 is a longitudinal sectional view illustrating the layer structure of an adhesive paper.

In FIG. 2, the reference numeral 20 indicates an adhesive paper which comprises a lowermost base 21 having a release-treated surface, an adhesive layer 22 provided on the base 21 and a paper 23 provided as a label thereon.

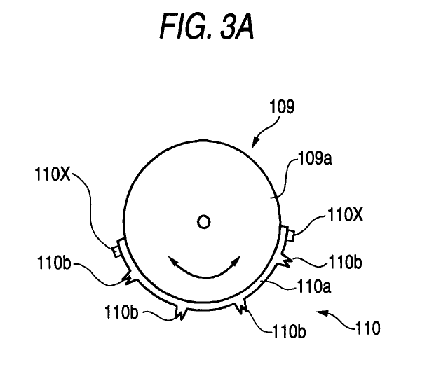

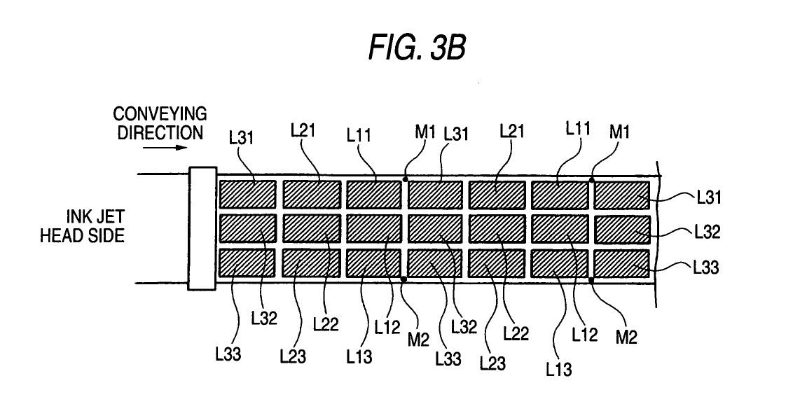

Using an ink jet head, a label is recorded on the surface of the paper 23. Using a die cutter 110b (FIG. 3) having a blade having a shape coinciding with that of the label mounted thereon described later, the paper 23 and the adhesive layer 22 are cut from above to the thickness thereof, leaving the paper 23 and the adhesive layer 22 at the label printed portion on the base 21. The leftover developed by cutting the label is peeled off the base 21 and then discarded.

Explain again FIG. 1, while the recording medium S which has been unwound from the adhesive paper wound in a roll is being conveyed under a full-line head 102K of K (black) color comprising a large number of ink jet nozzles aligned in the width direction of the recording medium S (perpendicular to the paper as viewed on the drawing), a K color ink is recorded on the recording medium S according to the desired image of label. The K color ink ejected on the recording medium S is then immediately irradiated with active energy and fixed while passing under an active energy-curing lamp 103. Subsequently, while the recording medium S is being conveyed under a full-line head 102C of C (cyan) color comprising a large number of ink jet nozzles aligned in the width direction of the recording medium S, a C color ink is recorded on the recording medium S according to the desired image of label. The C color ink ejected on the recording medium S is then immediately irradiated with active energy and fixed while passing under the active energy-curing lamp 103. Subsequently, while the recording medium S is being conveyed under a full-line head 102M of M (magenta) color comprising a large number of ink jet nozzles aligned in the width direction of the recording medium S, a M color ink is recorded on the recording medium S according to the desired image of label. The M color ink ejected on the recording medium S is then immediately irradiated with active energy and fixed while passing under the active energy-curing lamp 103. Finally, while the recording medium S is being conveyed under a full-line head 102Y of Y (yellow) color comprising a large number of ink jet nozzles aligned in the width direction of the recording medium S, a Y color ink is recorded on the recording medium S according to the desired image of label. The Y color ink ejected on the recording medium S is then immediately irradiated with active energy and fixed while passing under the active energy-curing lamp 103. In this arrangement, a label is recorded with four color inks.

The label thus recorded passes through the gap between the buffer 104 composed of several upper rollers 104a and several lower rollers 104b while ascending and descending. The buffer 104 is an adjusting portion for absorbing the difference in operating speed (conveying speed of recording medium S) between the upstream ink jet recording portion 100A and the downstream die cutting portion 100B.

Disposed downstream of the buffer 104 is a varnish coater 105. Using the varnish coater 105, a varnish is spread over the surface of the label to a small thickness to enhance the scratch resistance of the surface of the label.

Disposed downstream of the varnish coater 105 is a label cutting portion 106 comprising a marking reader 107, a die cutter driver 108, a die cutter 109 having a wound material 110 having a blade mounted thereon and an opposite roller 111.

The label cut by the die cutter 109 of the label cutting portion 106 is then wound as a product on a label winding portion 114 disposed downstream of a branching roller 112. The residue thus produced is discarded at a residue collecting portion 113.

FIG. 3 comprises a longitudinal sectional view (a) illustrating the configuration of a die cutter for cutting the label recorded at the full-line head 102 and a plan view (b) illustrating the recorded label to be cut.

In FIG. 3A, the die cutter 109 is composed of a cylinder 109a whose surface is wound with a wound material 110 made of a base 110a to which a blade 110b (four lines as viewed on the drawing) is mounted. The reason why the blade 110b is wound on the surface of the cylinder 109a is that since the length in the conveying direction depends on the size of seal, it is uneconomical to prepare die cutting cylinders having various diameters in correspondence to the size of seal. In the invention, although only one cylinder is prepared, a large number of wound materials having blades mounted apart from each at different intervals are prepared. One of these wound materials corresponding to the seal supplied is wound on the cylinder to constitute the die cutter.

In this arrangement, however, there exists a region along the circumferential direction of the cylinder where no wound material 110 is disposed. Therefore, when the die cutter 109 is rotated at 360 degrees like rotary press, the recording medium S is partly wasted.

In the invention, the system is not used in such a way. Instead, the recording medium S is intermittently conveyed. In some detail, when the recording starting position of the recording medium S comes directly under the die cutter 109, the conveyance of the recording medium S is then suspended. At the same time, the forward end of the circumferential region having the blade 110b of the die cutter 109 is caused to coincide with the recording staring point of the recording medium S. The cylinder is then started to rotate while the recording medium S is started to be conveyed at the same speed as the circumferential speed of the die cutter 109. In this manner, the cover paper of the surface of the recording medium S is cut. When the region of the last blade passes, the rotation of the die cutter 109 and the conveyance of the recording medium S are then suspended. The die cutter 109 is then lifted up. The die cutter 109 is then rotated in the opposite direction until the forward end of the circumferential region having a blade comes directly under the cylinder. The rotation in the opposite direction is then suspended. The die cutter 109 is then descended to the top of the recording medium S. The die cutter 109 is then rotated in the forward direction while the recording medium S is started to be conveyed so that the release paper of the surface of the recording medium S is cut.

Thus, in the invention, the recording medium S is intermittently conveyed while the cylinder is rocked and rotated, whereby the wasting of the recording medium is eliminated.

Accordingly, the timing of the intermittent conveyance is controlled by the effective use of marks M1 and M2 made on the recording medium.

In FIG. 3B, the shaded portion indicates a label which has just been recorded by a full-line head disposed upstream (left side as viewed on the drawing). In this drawing, L11, L12 and L13 at the first line, L21, L22 and L23 at the second line and L31, L32 and L33 at the third line constitute one group (one batch to be cut).

Subsequently, in accordance with the invention, marks M1 and M2 are recorded on the site on the recording medium S where no recording has been made every point positioned shortly before the first line of L11, L12 and L13. By making marks M1 and M2 at the edge of the recording medium every one batch of cutting, the end head of the full-line jet head (102K to 102Y in FIG. 1), which is less frequently used, can be regularly used, making it possible to eliminate clogging of nozzle of the end head.

The starting position of marking M1 and M2 is determined at the site shortly before the first line of L11, L12 and L13, i.e., site indicating the longitudinal position at which cutting of the recording medium starts. Referring to the color of marks M1, M2, inks may be ejected from the both end heads of the four color Y, M, C and K full-line ink jet heads onto the same starting position to make a four color mark. Alternatively, the color of ink may vary from mark to mark. In other words, any marks may be made so far as they can be read out by the marking reader 107 (FIG. 1).

The marks M1 and M2 are optically read out by the marking reader 107. The reading is inputted into the die cutter driver 108 which in turn controls the die cutter 109 such that the blade comes at the cutting starting position.

The signal read out by the marking reader 107 is sent also to a recording medium conveyance controlling portion (not shown) where the distance between the position at which reading is made by the marking reader 107 and the position at which cutting by the die cutter 109 starts is divided by the present conveying speed to determine the time between the reception of signal read and the suspension of conveyance. By suspending conveyance during this period of time, the forward end of cutting of label of recording medium S can be coincident with the cutting starting position.

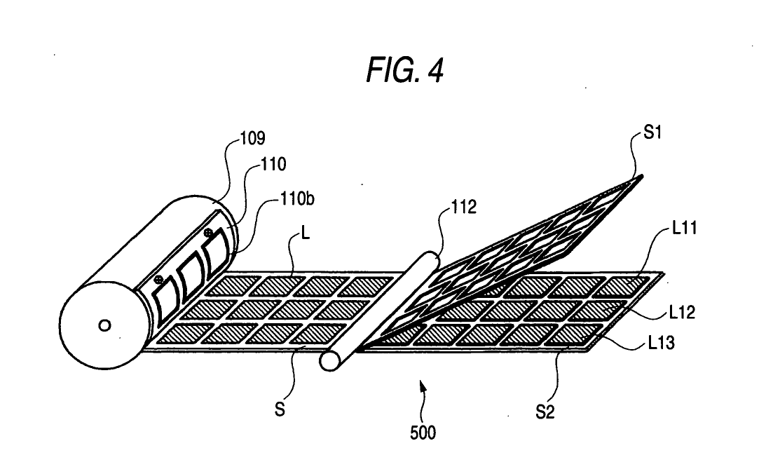

FIG. 4 depicts a perspective view of area in the vicinity of a branching roller for branching the recording medium S.

The label L cut by the die cutter 109 having the blade 110b provided thereon is then (optionally processed at a step of sticking a seal to necessary position) branched to a lower part and an upper part downstream of the branching roller 112. The base S2 on which the labels L11, L12 and L13 is then wound as a label product on the label winding portion 114 (FIG. 1). The leftover S1 of cover paper from which the labels have been withdrawn proceeds upward until it is discarded at the residue collecting portion 113 (FIG. 1).

While the foregoing description has been made with reference to the case of automatic cutting by die cutter, as the automatic cutter there may be used a laser cutter which uses laser beam to burn out the surface of the recording medium instead of the aforementioned die cutter.

In some cases, the printed label may be cut manually rather than automatically. In this case, too, the end heads, which are less frequently used, in the full-line ink jet head (102K to 102Y in FIG. 1) can be used to make a mark at the both edges of the recording medium S every label. Thus, accurate cutting can be easily made with a ruler applied between the marks.

### EXAMPLE 2

While the foregoing description has been made with reference to the case where the single pass printer and the post-processing device are connected to each other to allow continuous operation, the single pass printer and the post-processing device may be separately installed to allow off-line printing.

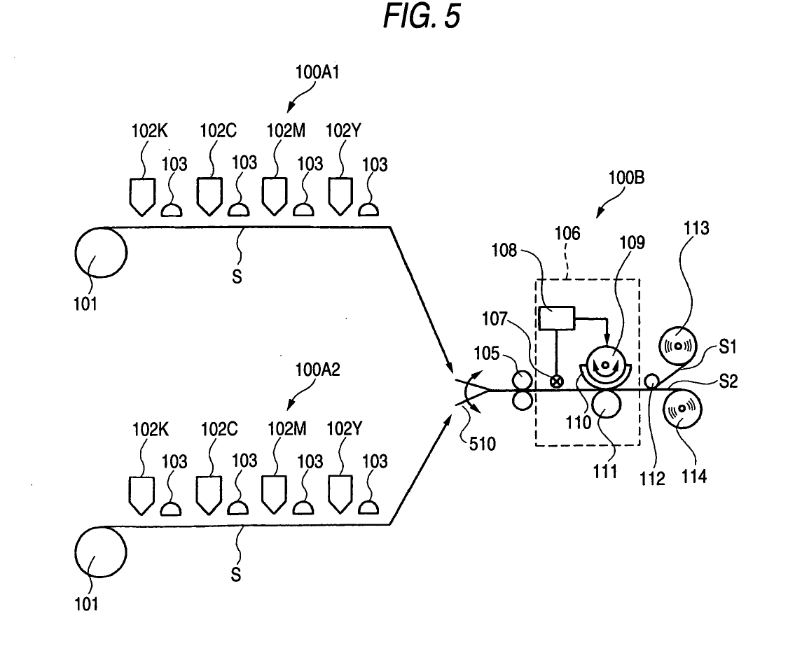

FIG. 5 is a diagram illustrating an off-line printing system which is Example 2 of the invention.

In FIG. 5, the reference numeral 500 indicates an off-line printing device according to the invention. The reference numerals 100A1 and 100A2 each correspond to the ink jet recording portion 100A described in FIG. 1. Similarly, the reference numeral 100B corresponds to the die cutting portion described as a post-processing device in FIG. 1. Therefore, these parts will not be described.

The reference numeral 510 indicates a switching portion for switching the process from the ink jet recording portion 100A1 or from the ink jet recording portion 100A2 so that the recording medium S is conveyed into the die cutting portion 100B.

The ink jet recording portions 100A1 and 100A2 each perform single pass printing. Therefore, their printing speed (i.e., conveying speed) is lower than the conveying speed at the die cutting portion 100B as post-processing device. Accordingly, while the die cutting portion 100B in Example 1 has a low operating efficiency, Example 2 is arranged such that for one post-processing device, two single pass printing machines (of course, three or more single pass printing machines may be provided) are provided and switched, allowing efficient printing.

### EXAMPLE 3

While the foregoing description has been made with reference to die cutting as a post-processing, other post-processing steps include “foil stamping” which comprises sticking a gold foil, silver foil or other foil (hereinafter referred to as “gold foil”) to the surface of the label under pressure to provide the label with a high-grade appearance.

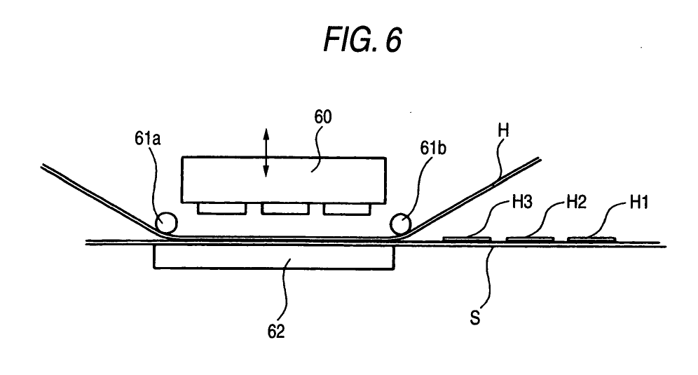

FIG. 6 is a diagram illustrating a foil stamper as an example of the post-processing device according to the invention.

In the drawing, the stamper 60 is disposed above a press table 62 during standby mode and descends toward the press table 62 during transfer mode. The recording medium S (herein an adhesive paper) is conveyed onto the press table 62 where it is then stopped. On the other hand, a sheet H having a gold foil placed thereon is conveyed onto the adhesive paper where it is then stopped by conveying rollers 61a, 61b. Under these conditions, the stamper 60 descends toward the press table 62 from the standby position to press the gold foil sheet H so that the gold H is transferred to the adhesive paper S at a desired position. Thereafter, the stamper 60 shunts to the standby position. The adhesive paper is wound up over the length having a gold foil sheet H transferred thereto and the subsequent portion of gold foil seal is moved onto the press table 62. The adhesive paper S having three lines of gold foil (H1, H2, H3) transferred thereto at one time foil pressing operation is moved to the subsequent step from the press table 62. The subsequent batch of the adhesive paper S is then moved onto the press table 62. In order to effect the positioning of the adhesive paper S and the stamper 60, the marks M1 and M2 made according to the invention are used. Examples of the stamper 60 employable herein include hot stamper which comprises applying heat at the same time with pressing to effect transfer and a cold stamper which effects transfer without applying heat. Either one of these stampers may be used.

As mentioned above, in accordance with the invention, a mark indicating the longitudinal position of the recording medium is regularly made on the edge of the recording medium from the end head of the full-line ink jet head. By making the use of this marking, the positioning of the blade during manual cutting or the positioning of the blade of the rocking and rotating die cut during cutting into the size of label and the timing of descending of the stamper by the gold foil transferring device can be made (that is, the effective use of marking can be made). Therefore, ink wasting such as mere “blank shot” of ink from the end head only for the purpose of eliminating nozzle clogging can be eliminated, making it possible to obtain an inexpensive ink jet recording device capable of effecting recording on various recording media at a high productivity.

As the ink composition to be used in the invention there is preferably used an ink composition which can be cured particularly when irradiated with active energy.

The term “active energy” as used herein is meant to include various energies capable of generating starting seeds in the ink composition being irradiated therewith such as a ray, γ ray, X-ray, ultraviolet ray, visible light and electron ray. Thus, active energy to be used herein is not specifically limited. Preferred among these active energies are ultraviolet ray and electron ray from the standpoint of curing sensitivity and availability of device. Particularly preferred among these active energies is ultraviolet ray. Accordingly, the ink composition of the invention is preferably an ink composition which can be cured when irradiated with ultraviolet ray.

In the ink jet recording device of the invention, the peak wavelength of active energy, though depending on the absorption characteristics of the sensitizing dye in the ink composition, is from 200 nm to 600 nm, for example, preferably from 300 nm to 450 nm, more preferably from 350 nm to 450 nm. The electron migration type starting system (a) of the ink composition of the invention has a sufficient sensitivity even when a low output active energy is used. Accordingly, the output of active energy is 2,000 mJ/cm² or less, for example, preferably from 10 to 2,000 mJ/cm², more preferably from 20 to 1,000 mJ/cm², even more preferably from 50 to 800 mJ/cm² as calculated in terms of emission energy. The active energy is emitted in such a manner that the illuminance at the exposed surface (maximum illuminance at the surface of the recording medium) is from 10 to 2,000 mW/cm², for example, preferably from 20 to 1,000 mW/cm².

In the ink jet recording device of the invention in particular, the active energy is preferably emitted from a light-emitting diode capable of emitting an active energy having an emission wavelength peak of from 390 nm to 420 nm and a maximum illuminance of from 10 to 1,000 mW/cm² at the surface of the recording medium.

Further, in the ink jet recording device of the invention, the active energy is preferably allowed to hit the ink composition ejected on the recording medium for 0.01 to 120 seconds, preferably 0.1 to 90 seconds.

Moreover, in the ink jet recording device of the invention, while being heated to a predetermined temperature, the ink composition is allowed to hit the recording medium and then irradiated with active energy in 0.01 to 0.5 seconds, preferably 0.02 to 0.3 seconds, more preferably 0.03 to 0.15 seconds. By thus controlling the period of time between the hitting of the ink composition to the recording medium and the irradiation of the ink composition with active energy to an extremely small value, the ink composition which has hit the recording medium can be prevented from bleeding before curing.

In order to obtain a color image using the ink jet recording device of the invention, inks are preferably superimposed on each other in order of brightness. When inks are superimposed on each other in this manner, the active energy can easily reach the lower ink, making it possible to expect the provision of good curing sensitivity, the reduction of residual monomer, the elimination of odor and the enhancement of adhesion. The emission of active energy can be made in such a manner that all the inks are altogether exposed but is preferably made in such a manner that exposure is effected every color from the standpoint of acceleration of curing.

The ink jet head of the invention is, e.g., a piezoelectric inkjet head. This piezoelectric ink jet head can drive a multi-size dot of from 1 to 100 pl, preferably from 1 to 30 pl at a resolution of from 320×320 to 4,000×4,000 dpi, preferably from 400×400 to 2,400×2,400 dpi. The term “dpi” as used herein is meant to indicate the number of dots per 2.54 cm.

As mentioned above, the active energy-curing ink such as ink composition of the invention is preferably temperature-controlled by insulation and heating over the range between the ink supplying cartridge and the ink jet head because the ink composition to be ejected is preferably kept at a constant temperature. Further, the head unit to be heated is preferably thermally shielded or insulated so that the main body of the device cannot be affected by the external temperature. In order to reduce the printer rising time required for heating or reduce the loss of heat energy, the heat unit is preferably insulated from other sites and the heat capacity of the entire heating unit is preferably reduced.

As the active energy source there is mainly used a mercury vapor lamp, gas laser, solid laser or the like. For active energy-curing ink jets, mercury vapor lamp and metal halide lamp have been widely known. Further, the replacement by GaN-based semiconductor ultraviolet-emitting device is industrially and environmentally useful. Further, LED (UV-LED) and LD (UV-LD) are small-sized, long-lived and inexpensive and thus are expected to be an active energy-curing ink jet radiation source.

As mentioned above, as the active energy source there may be used a light-emitting diode (LED) or laser diode (LD). In particular, in the case where an active energy source is required, an ultraviolet LED or ultraviolet LD may be used. For example, Nichia Corporation has marketed a violet LED having a main emission spectrum having a wavelength of from 365 nm to 420 nm. In the case where a shorter wavelength is required, U.S. Pat. No. 6,084,250 discloses an LED capable of emitting active energy centered between 300 nm and 370 nm. Further, other ultraviolet LED's are available. These ultraviolet LED's can emit radiations having different active energy ranges. The active energy source which is particularly preferably used in the invention is UV-LED, preferably having a peak wavelength of from 350 nm to 420 nm.

### (Recording Medium)

The adhesive paper to be used in the invention is not specifically limited. Paper such as ordinary non-coated paper and coated paper to be used as cover paper, various non-absorbing resin materials to be used for so-called light packaging or resin films formed therefrom can be used. Examples of these plastic films include PET film, OPS film, OPP film, ONy film, PVC film, PE film, and TAC film.

The respective constitutional components to be used in the ink composition which can be used in the invention will be hereunder described in order.

### (Ink Composition)

The ink composition which is used in the invention is an ink composition which is curable by irradiation with active energy, and examples thereof include a cationic polymerization based ink composition, a radical polymerization based ink composition, and an aqueous ink composition. These compositions will be hereunder described in detail.

### (Cationic Polymerization Based Ink Composition)

The cationic polymerization based ink composition contains (a) a cationic polymerizable compound and (b) a compound capable of generating an acid by irradiation with active energy. If desired, the cationic polymerization based ink composition may further contain (d) an organic acidic component having a pk value of from 2 to 6, (e) a coloring agent, and the like.

The respective constitutional components which are used in the cationic polymerization based ink composition will be hereunder described in order.

((a) Cationic Polymerizable Compound)

The cationic polymerizable compound (a) which is used in the invention is not particularly limited so far as it is a compound which causes a polymerization reaction due to an acid as generated from (b) a compound capable of generating an acid by irradiation with active energy as described later and is then cured, and various known cationic polymerizable monomers which are known as a photo cationic polymerizable monomer can be used. Examples of the cationic polymerizable monomer include epoxy compounds, vinyl ether compounds, and oxetane compounds as described in, for example, JP-A-6-9714, JP-A-2001-31892, JP-A-2001-40068, JP-A-2001-55507, JP-A-2001-310938, JP-A-2001-310937, and JP-A-2001-220526.

Examples of the epoxy compound include aromatic epoxides, alicyclic epoxides, and aliphatic epoxides.

As the aromatic epoxide, there are enumerated di- or polyglycidyl ethers resulting from a reaction of a polyhydric phenol having at least one aromatic nucleus or an alkylene oxide adduct thereof with epichlorohydrin. Examples thereof include di- or polyglycidyl ethers of bisphenol A or an alkylene oxide adduct thereof, di- or polyglycidyl ethers of hydrogenated bisphenol A or an alkylene oxide adduct, and novolak type epoxy resins. Here, examples of the alkylene oxide include ethylene oxide and propylene oxide.

As the alicyclic epoxide, there are preferably enumerated cyclohexene oxide-containing or cyclopentene oxide-containing compounds which are obtained by epoxidizing a compound having at least one cycloalkene ring such as a cyclohexene ring and a cyclopentene ring with a suitable oxidizing agent such as hydrogen peroxide and peracids.

As the aliphatic epoxide, there are enumerated di- or polyglycidyl ethers of an aliphatic polyhydric alcohol or an alkylene oxide adduct thereof. Representative examples thereof include diglycidyl ethers of an alkylene glycol such as diglycidyl ether of ethylene oxide, diglycidyl ether of propylene glycol, and diglycidyl ether of 1,6-hexanediol; polyglycidyl ethers of a polyhydric alcohol such as di- or triglycidyl ethers of glycerin or an alkylene oxide adduct thereof; and diglycidyl ethers of a polyalkylene glycol represented by diglycidyl ethers of polyethylene glycol or an alkylene oxide adduct thereof and diglycidyl ethers of polypropylene glycol or an alkylene oxide adduct thereof. Here, examples of the alkylene oxide include ethylene oxide and propylene oxide.

The epoxy compound may be monofunctional or polyfunctional.

Examples of the monofunctional epoxy compound which can be used in the invention include phenyl glycidyl ether, p-tert-butylphenyl glycidyl ether, butyl glycidyl ether, 2-ethylhexyl glycidyl ether, allyl glycidyl ether, 1,2-butylene oxide, 1,3-butadiene monoxide, 1,2-epoxydodecane, epichlorohydrin, 1,2-epoxydecane, styrene oxide, cyclohexene oxide, 3-methacryloyloxymethylcyclohexene oxide, 3-ac-ryloyloxymethylcyclohexene oxide, and 3-vinylcyclohexene oxide.

Furthermore, examples of the polyfunctional epoxy compound include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolak resins, hydrogenated bisphenol A diglycidyl ether, hydrogenated bisphenol F diglycidyl ether, hydrogenated bisphenol S diglycidyl ether, 3,4-epoxycyclo-hexylmethyl-3′,4′-epoxycyclohexane carboxylate, 2-(3,4-epoxy-cyclohexyl-5,5-spiro-3,4-epoxy)cyclohexane-m-dioxane, bis-(3,4-epoxycyclohexylmethyl)adipate, vinylcyclohexene oxide, 4-vinylepoxycyclohexane, bis(3,4-epoxy-6-methylcyclohexyl-methyl)adipate, 3,4-epoxy-6-methylcyclohexyl-3′,4′-epox-y-6′-methylcyclohexane carboxylate, methylenebis(3,4-e-poxycyclohexane), dicyclopentadiene diepoxide, di(3,4-e-poxycyclohexylmethyl)ether of ethylene glycol, ethylene-bis(3,4-epoxycyclohexane carboxylate), dioctyl epoxy-hexahydrophthalate, di-2-ethylhexyl epoxyhexahydrophthalate, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ethers, 1,1,3-tetradecadiene dioxide, limonene dioxide, 1,2,7,8-diepoxyoctane, and 1,2,5,6-diepoxycyclooctane.

Of these epoxy compounds, from the viewpoint of excellent curing rate, aromatic epoxides and alicyclic epoxides are preferable; and alicyclic epoxides are especially preferable.

Examples of the vinyl ether compound include di- or trivinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether; and monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl ether-O-propylene carbonate, dodecyl vinyl ether, diethylene glycol monovinyl ether, and octadecyl vinyl ether.

The vinyl ether compound may be monofunctional or poly-functional.

Concretely, examples of the monofunctional vinyl ether include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexylmethyl vinyl ether, 4-methylcyclohexylmethyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, and phenoxypolyethylene glycol vinyl ether.

Furthermore, examples of the polyfunctional vinyl ether include divinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ethers, and bisphenol F alkylene oxide divinyl ethers; and polyfunctional vinyl ethers such as trimethylolethane trivinyl ether, trimethylolpropane trivinyl ether, ditrimethylolpropane tetravinyl ether, glycerin trivinyl ether, pentaerythritol tetravinyl ether, dipentaerythritol pentavinyl ether, dipentaerythritol hexavinyl ether, ethylene oxide-added trimethylolpropane trivinyl ether, propylene oxide-added trimethylolpropane trivinyl ether, ethylene oxide-added ditrimethylolpropane tetravinyl ether, propylene oxide-added ditrimethylolpropane tetravinyl ether, ethylene oxide-added pentaerythritol tetravinyl ether, propylene oxide-added pentaerythritol tetravinyl ether, ethylene oxide-added dipentaerythritol hexavinyl ether, and propylene oxide-added dipentaerythritol hexavinyl ether.

As the vinyl ether compound, from the viewpoints of curing properties, adhesion to the medium to be recorded and surface hardness of the formed image, di- or trivinyl ether compounds are preferable; and divinyl ether compounds are especially preferable.

The oxetane compound as referred to in the invention means a compound having an oxetane ring and can be arbitrarily selected and used among known oxetane compounds as described in JP-A-2001-220526, JP-A-2001-310937, and JP-A-2003-341217.

As the compound having an oxetane ring which can be used in the ink composition of the invention, compounds having from one to four oxetane rings in the structure thereof are preferable. By using such a compound, it becomes easy to keep the ink composition so as to make a viscosity fall within the range suitable for handling properties. Furthermore, it is possible to obtain high adhesion between the ink composition and the medium to be recorded after curing.

Such a compound having an oxetane ring is described in detail in paragraphs [0021] to [0084] of JP-A-2003-341217, and compounds as described in this patent document can also be suitably used in the invention.

Of the oxetane compounds which are used in the invention, it is preferred to use a compound having one oxetane ring from the viewpoints of viscosity and adhesiveness of the ink composition.

In the ink composition of the invention, such a cationic polymerizable compound may be used singly or in combination of two or more kinds thereof. However, from the viewpoint of the matter that shrinkage at the time of curing of the ink is effectively controlled, it is preferred to use a combination of at least one compound selected from oxetane compounds and epoxy compounds with a vinyl ether compound.

The content of the cationic polymerizable compound (a) in the ink composition is suitably in the range of from 10 to 95% by weight, preferably from 30 to 90% by weight, and more preferably from 50 to 85% by weight with respect to the whole of solids of the composition.

((b) Compound Capable of Generating an Acid by Irradiation with Active Energy)

The ink composition of the invention contains a compound capable of generating an acid by irradiation with active energy (hereinafter properly referred to as “photo acid generating agent”).

As the photo acid generating agent which can be used in the invention, compounds capable of generating an acid by irradiation of rays (for example, ultraviolet rays and far ultraviolet rays having a wavelength of from 400 to 200 nm; especially preferably g-rays, h-rays, i-rays, and KrF excimer lasers), ArF excimer lasers, electron beams, X-rays, molecular rays, or ion beams, which are used in photo cationic polymerization photoinitiators, photo radical polymerization photoinitiators, photo decolorizing agents of dyes, photo discoloring agents, or micro resists, can be properly selected and used.

Examples of such a photo acid generating agent include compounds which are decomposed by irradiation with active energy to generate an acid such as onium salts (for example, diazonium salts, ammonium salts, phosphonium salts, iodonium salts, sulfonium salts, selenonium salts, and arsonium salts), organic halogen compounds, organic metals or organic halides, photo acid generating agents having an o-nitrobenzyl type protective group, compounds which are photo decomposed to generate sulfonic acid, represented by imino sulfonate, disulfone compounds, diazo keto sulfone, and diazo disulfone compounds.

Also, oxazole derivatives and s-triazine derivatives as described in paragraphs [0029] to [0030] of JP-A-2002-122994 can be suitably used as the photo acid generating agent. In addition, onium salt compounds and sulfonate based compounds as enumerated in paragraphs [0037] to [0063] of JP-A-2002-122994 can be suitably used as the photo acid generating agent in the invention.

The photo acid generating agent (b) can be used singly or in combination with two or more kinds thereof.

The content of the photo acid generating agent (b) in the ink composition is preferably from 0.1 to 20% byweight, more preferably from 0.5 to 10% by weight, and further preferably from 1 to 7% by weight with respect to the whole of solids of the ink composition.

In addition to the foregoing essential components, various additives can be used jointly in the ink composition of the invention depending upon the purpose. These arbitrary components will be hereunder described.

((e) Coloring Agent)

In the ink composition of the invention, by adding a coloring agent, it is possible to form a visible image. For example, in the case of forming an image area region of a lithographic printing plate, though it is not always required to add a coloring agent, it is preferred to use a coloring agent from the viewpoint of plate inspection properties of the resulting lithographic printing plate.

The coloring agent which can be used herein is not particularly limited but can be properly selected and used among various known coloring materials (for example, pigments and dyes) depending upon the utilization. For example, in the case of forming an image having excellent weather resistance, a pigment is preferable. As the dye, though any of water-soluble dyes and oil-soluble dyes can be used, oil-soluble dyes are preferable.

### (Pigment)

The pigment which is preferably used in the invention will be hereunder described.

The pigment is not particularly limited. For example, all organic pigments and inorganic pigments which are generally commercially available, substances resulting from dispersing a pigment in, as a dispersion medium, an insoluble resin, etc., and substances resulting from grafting a resin on the surface of a pigment can be used. Substances resulting from dyeing a resin particle with a dye can also be used.

Examples of such a pigment include pigments as described in Ganryo No Jiten (Pigment Dictionary), edited by Seishiro ITO (published in 2000), W. Herbst and K. Hunger, Industrial organic Pigments, JP-A-2002-12607, JP-A-2002-188025, JP-A-2003-26978, and JP-A-2003-342503.

Specific examples of the organic pigment and the inorganic pigment which can be used in the invention are as follows. That is, examples of pigments which exhibit a yellow color include monoazo pigments such as C.I. Pigment Yellow 1 (for example, Fast Yellow G) and C.I. Pigment Yellow 74; disazo pigments such as C.I. Pigment Yellow 12 (for example, Disazo Yellow AAA) and C.I. Pigment Yellow 17; non-benzidine based azo pigments such as C.I. Pigment Yellow 180; azo lake pigments such as C.I. Pigment Yellow 100 (for example, Tartrazine Yellow Lake); condensed azo pigments such as C.I. Pigment Yellow 95 (for example, Condensed Azo Yellow GR); acid dye lake pigments such as C.I. Pigment Yellow 115 (for example, Quinoline Yellow Lake); basic dye lake pigments such as C.I. Pigment Yellow 18 (for example, Thioflavine Lake); anthraquinone based pigments such as Flavanthrone Yellow (Y-24); isoindolinone pigments such as Isoindolinone Yellow 3RLT (Y-110); quinophthalone pigments such as Quinophthalone Yellow (Y-138); isoindoline pigments such as Isoindoline Yellow (Y-139); nitroso pigments such as C.I. Pigment Yellow 153 (for example, Nickel Nitroso Yellow); and metal complex salt azomethine pigments such as C.I. Pigment Yellow 117 (for example, Copper Azomethine Yellow).

Examples of pigments which exhibit a red or magenta color include monoazo based pigments such as C.I. Pigment Red 3 (for example, Toluidine Red); disazo pigments such as C.I. Pigment Red 38 (for example, Pyrazolone Red B); azo lake pigments such as C.I. Pigment Red 53:1 (for example, Lake Red C) and C.I. Pigment Red 57:1 (for example, Brilliant Carmine 6B); condensed azo pigments such as C.I. Pigment Red 144 (for example, Condensed Azo Lake BR); acid dye lake pigments such as C.I. Pigment Red 174 (for example, Phloxine B Lake); basic dye lake pigments such as C.I. Pigment Red 81 (for example, Rhodamine 6G′ Lake); anthraquinone based pigments such as C.I. Pigment Red 177 (for example Dianthraquinonyl Red); thioindigo pigments such as C.I. Pigment Red 88 (for example, Thioindigo Bordeaux); perinone pigments such as C.I. Pigment Red 194 (for example, Perinone Red); perylene pigments such as C.I. Pigment Red 149 (for example, Perylene Scarlet); quinacridone pigments such as C.I. Pigment Violet 19 (for example, unsubstituted quinacridone) and C.I. Pigment Red 122 (for example, Quinacridone Magenta); isoindolinone pigments such as C.I. Pigment Red 180 (for example, Isoindolinone Red 2BLT); and alizarine lake pigments such as C.I. Pigment Red 83 (for example, Madder Lake).

Examples of pigments which exhibit a blue or cyan color include disazo based pigments such as C.I. Pigment Blue 25 (for example, Dianisidine Blue); phthalocyanine pigments such as C.I. Pigment Blue 15 (for example, Phthalocyanine Blue); acid dye lake pigments such as C.I. Pigment Blue 24 (for example, Peacock Blue Lake); basic dye lake pigments such as C.I. Pigment Blue 1 (for example, Victoria Pure Blue BO Lake); anthraquinone based pigments such as C.I. Pigment Blue 60 (for example, Indanthrone Blue); and alkali blue pigments such as C.I. Pigment Blue 18 (for example, Alkali Blue V-5:1).

Examples of pigments which exhibit a green color include phthalocyanine pigments such as C.I. Pigment Green 7 (Phthalocyanine Green) and C.I. Pigment Green 36 (Phthalocyanine Green); and azo metal complex pigments such as C.I. Pigment Green 8 (Nitroso Green).

Examples of pigments which exhibit an orange color include isoindoline based pigments such as C.I. Pigment Orange 66 (Isoindoline Orange); and anthraquinone based pigments such as C.I. Pigment Orange 51 (Dichloropyranthrone Orange).

Examples of pigments which exhibit a black color include carbon black, titanium black, and aniline black.

Specific examples of white pigments which can be used include basic lead carbonate (2PbCO₃Pb(OH)₂, so-called “silver white”), zinc oxide (ZnO, so-called “zinc white”), titanium oxide (TiO₂, so-called “titanium white”), strontium titanate (SrTiO₃, so-called “titanium strontium white”).

Here, titanium oxide has a low specific gravity and a high refractive index and is chemically and physically stable as compared with other white pigments. Thus, the titanium oxide has large covering power and coloring power as a pigment and has excellent durability against acids, alkalis and other environments. Accordingly, it is preferred to use titanium oxide as the white pigment. As a matter of course, other white pigments (other white pigments than those as enumerated previously may also be used) may be used as the need arises.

For dispersing the pigment, dispersing units such as a ball mill, a sand mill, an attritor, a roll mill, a jet mill, a homogenizer, a paint shaker, a kneader, an agitator, a Henschel mixer, a colloid mill, an ultrasonic homogenizer, a pearl mill, and a wet jet mill can be employed.

In dispersing the pigment, it is also possible to add a dispersant. Examples of the dispersant include hydroxyl group-containing carboxylic acid esters, salts between a long chain polyaminoamide and a high molecular acid ester, salts of a high molecular polycarboxylic acid, high molecular unsaturated acid esters, high molecular copolymers, modified polyacrylates, aliphatic polyhydric carboxylic acids, naphthalenesulfonic acid formalin condensates, polyoxyethylene alkylphosphoric esters, and pigment derivatives. It is also preferred to use a commercially available high molecular dispersant such as Zeneca's SOLSPERSE Series.

Furthermore, it is possible to use, as a dispersing agent, a synergist adaptive to a pigment of every kind. It is preferable that such a dispersant or dispersing agent is added in an amount of from 1 to 50 parts by weight based on 100 parts by weight of the pigment.

In the ink composition, a solvent may be added as a dispersion medium for various components inclusive of the pigment. Also, the foregoing cationic polymerizable compound (a) which is a low molecular component may be used as the dispersion medium in the absence of a solvent. However, since the ink composition of the invention is an active energy curing type ink and after applying on the medium to be recorded, the ink is cured, it is preferred that the ink composition is free from a solvent. This is because when the solvent remains in the cured ink image, the solvent resistance is deteriorated or the residual solvent causes a problem of VOC (volatile organic compound). In view of the foregoing, what the cationic polymerizable compound (a) is used as the dispersion medium, especially a cationic polymerizable monomer having the lowest viscosity is selected is preferable from the viewpoints of dispersing adaptability and improvement of handling properties of the ink composition.

An average particle size of the pigment is preferably in the range of from 0.02 to 4 μm, more preferably from 0.02 to 2 μm, and further preferably from 0.02 to 1.0 μm.

In order to make the average particle size of the pigment particle fall within the foregoing preferred range, the pigment, the dispersant and the dispersion medium are selected, and the dispersing condition and the filtration condition are set up. By managing the particle size, it is possible to control plugging of a head nozzle and to keep the storage stability of the ink and the transparency and curing sensitivity of the ink.

### (Dye)

As the dye which is used in the invention, an oil-soluble dye is preferable. Concretely, the oil-soluble dye is a dye having a solubility in water at 25° C. (weight of the dye which is dissolved in 100 g of water) of not more than 1 g, preferably not more than 0.5 g, and more preferably not more than 0.1 g. Accordingly, a so-called water-insoluble and oil-soluble dye is preferably used.

In the dye which is used in the invention, it is also preferred to introduce an oil-solubilizing group into the mother nucleus of the foregoing dye for the purpose of dissolving a necessary amount of the dye in the ink composition.

Examples of the oil-solubilizing group include a long chain or branched alkyl group, a long chain or branched alkoxy group, a long chain or branched alkylthio group, a long chain or branched alkylsulfonyl group, a long chain or branched acyloxy group, a long chain or branched alkoxycarbonyl group, a long chain or branched acyl group, a long chain or branched acylamino group, a long chain or branched alkylsulfonylamino group, and a long chain or branched alkylaminosulfonyl group; and an aryl group, an aryloxy group, an aryloxycarbonyl group, an arylcarbonyloxy group, an arylaminocarbonyl group, an arylaminosulfonyl group, and an arylsulfonylamino group each containing the foregoing long chain or branched substituent.

Furthermore, with respect to the water-soluble dye having a carboxyl acid or a sulfonic acid, a dye may be obtained by converting it into an oil-solubilizing group including an alkoxycarbonyl group, an aryloxycarbonyl group, an alkylaminosulfonyl group, and an arylaminosulfonyl group using a long chain or branched alcohol, amine, phenol or aniline derivative.

The oil-soluble dye is preferably an oil-soluble dye having a melting point of not higher than 200° C., more preferably an oil-soluble dye having a melting point of not higher than 150° C., and further preferably an oil-soluble dye having a melting point of not higher than 100° C. By using an oil-soluble dye having a low melting point, deposition of a crystal of the dye in the ink composition is controlled, and the storage stability of the ink composition is improved.

Furthermore, for the purpose of improving fading, especially resistance to oxidizers such as ozone and curing characteristics, it is preferable that the oxidation potential is noble (high). For that reason, an oil-soluble dye having an oxidation potential of 1.0 V (vs SCE) or more is preferably used as the oil-soluble dye to be used in the invention. It is preferable that the oxidation potential is higher. The oxidation potential is more preferably 1.1 V (vs SCE) or more, and especially preferably 1.15 V (vs SCE) or more.

As a dye having a yellow color, compounds having a structure represented by the general formula (Y-I) as described in JP-A-2004-250483 are preferable.

Dyes represented by the general formulae (Y-II) to (Y-IV) as described in paragraph [0034] of JP-A-2004-250483 are especially preferable. Specific examples thereof include compounds as described in paragraphs [0060] to [0071] of JP-A-2004-250483. Incidentally, the oil-soluble dyes of the general formula (Y-I) as described in the subject patent document may be used for inks of any colors including not only yellow inks but also black inks and red inks.

As a dye having a magenta color, compounds having a structure represented by the general formulae (3) and (4) as described in JP-A-2002-114930 are preferable. Specific examples thereof include compounds as described in paragraphs [0054] to [0073] of JP-A-2002-114930.

Azo dyes represented by the general formulae (M-1) to (M-2) as described in paragraphs [0084] to [0122] of JP-A-2002-121414 are especially preferable. Specific examples thereof include compounds as described in paragraphs [0123] to [0132] of JP-A-2002-121414. Incidentally, the oil-soluble dyes of the general formulae (3), (4) and (M-1) to (M-2) as described in the subject patent document may be used for inks of any colors including not only magenta inks but also black inks and red inks.

As a dye having a cyan color, dyes represented by the general formulae (I) to (IV) as described in JP-A-2001-181547 and dyes represented by the general formulae (IV-1) to (IV-4) as described in paragraphs [0063] to [0078] of JP-A-2002-121414 are preferable. Specific examples thereof include compounds as described in paragraphs [0052] to [0066] of JP-A-2001-181547 and compounds as described in paragraphs [0079] to [0081] of JP-A-2002-121414.

Phthalocyanine dyes represented by the general formulae (C-I) and (C-II) as described in paragraphs [0133] to [0196] of JP-A-2002-121414 are especially preferable, with phthalocyanine dues represented by the general formula (C-II) being further preferable. Specific examples thereof include compounds as described in paragraphs [0198] to [0201] of JP-A-2002-121414. Incidentally, the oil-soluble dyes of the foregoing general formulae (I) to (IV), (IV-1) to (IV-4), (C-I) and (C-II) may be used for inks of any colors including not only cyan inks but also black inks and green inks.

Such a coloring agent is preferably added in an amount of from 1 to 20% by weight, and more preferably from 2 to 10% by weight with respect to the whole of solids in the ink composition.

### (Other Components)

Various additives which are used depending upon the situation will be hereunder described.

### (Ultraviolet Ray Absorber)

In the invention, an ultraviolet ray absorber can be used from the viewpoints of improving the weather resistance and preventing the fading on the resulting image.

Examples of the ultraviolet ray absorber include benzotriazole based compounds described in JP-A-58-185677, JP-A-61-190537, JP-A-2-782, JP-A-5-197075, and JP-A-9-34057; benzophenone based compounds as described in JP-A-46-2784, JP-A-5-194483, and U.S. Pat. No. 3,214,463; cinnamic acid based compounds as described in JP-B-48-303492, JP-B-56-21141, and JP-A-10-88106; triazine based compounds as described in JP-A-4-298503, JP-A-8-53427, JP-A-8-239368, JP-A-10-182621, and JP-T-8-501291; compounds as described in Research Disclosure, No. 24239; compounds capable of absorbing ultraviolet rays to emit fluorescence, as represented by stilbene based compounds and benzoxazole based compounds; and so-called fluorescent brighteners.

Though the amount of addition of the ultraviolet ray absorber is properly selected depending upon the purpose, it is generally from about 0.5 to 15% by weight as calculated as solids.

### (Sensitizer)

For the purposes of improving the acid generation efficiency of the photo acid generating agent and shifting the light-sensitive wavelength into a long wavelength side, a sensitizer may be added in the ink composition of the invention as the need arises. The sensitizer may be any sensitizer so far as it is able to sensitize the photo acid generating agent through an electron transfer mechanism or an energy transfer mechanism. Preferred examples thereof include aromatic polyfused compounds such as anthracene, 9,10-dialkoxyanthracenes, pyrene, and perylene; aromatic ketone compounds such as acetophenone, benzophenone, thioxanthone, and Michler's ketone; and heterocyclic compounds such as phenothiazine and N-aryloxazolidinones. Though the amount of addition of the sensitizer is properly selected depending upon the purpose, it is generally from 0.01 to 1% by mole, and preferably from 0.1 to 0.5% by mole with respect to the photo acid generating agent.

### (Antioxidant)

For the purpose of improving the stability of the ink composition, an antioxidant can be added. Examples of the antioxidant include antioxidants as described in EP-A-223739, EP-A-309401, EP-A-309402, EP-A-310551, EP-A-310552, EP-A-459416, DE-A-3435443, JP-A-54-48535, JP-A-62-262047, JP-A-63-113536, JP-A-63-163351, JP-A-2-262654, JP-A-2-71262, JP-A-3-121449, JP-A-5-61166, JP-A-5-119449, and U.S. Pat. Nos. 4,814,262 and 4,980,275.

Though the amount of addition of the antioxidant is properly selected depending upon the purpose, it is generally from about 0.1 to 8% by weight as calculated as solids.

### (Anti-Fading Agent)

In the ink composition of the invention, various organic or metal complex based anti-fading agents can be used. Examples of the organic anti-fading agent include hydroquinones, alkoxyphenols, dialkoxyphenols, phenols, anilines, amines, indanes, chromans, alkoxyanilines, and heterocyclic compounds. Examples of the metal complex based anti-fading agent include nickel complexes and zinc complexes. Concretely, compounds described in patents as cited in Research Disclosure, No. 17643, No. VII, Items I to J, ibid., No. 15162, ibid., No. 18716, page 650, left-hand column, ibid., No. 36544, page 527, ibid., No. 307105, page 872, and ibid., No. 15162; and compounds included in the general formulae of representative compounds and compound examples as describe on pages 127 to 137 of JP-A-62-215272 can be used.

Though the amount of addition of the anti-fading agent is properly selected depending upon the purpose, it is generally from about 0.1 to 8% by weight as calculated as solids.

### (Conductive Salt)

For the purpose of controlling injection physical properties, conductive salts such as potassium thiocyanate, lithium nitrate, ammonium thiocyanate, and dimethylamine hydrochloride can be added in the ink composition of the invention.

### (Solvent)

In the ink composition of the invention, for the purpose of improving adhesion to the medium to be recorded, it is also effective to add an extremely trace amount of an organic solvent.

Examples of the solvent include ketone based solvents such as acetone, methyl ethyl ketone, and diethyl ketone; alcohol based solvents such as methanol, ethanol, 2-propanol, 1-propanol, 1-butanol, and tert-butanol; chlorine based solvents such as chloroform and methylene chloride; aromatic solvents such as benzene and toluene; ester based solvents such as ethyl acetate, butyl acetate, and isopropyl acetate; ether based solvents such as diethyl ether, tetrahydrofuran, and dioxane; and glycol ether based solvents such as ethylene glycol monomethyl ether and ethylene glycol dimethyl ether.

In this case, it is effective to add the solvent in an amount within the range where problems in solvent resistance and VOC are not caused. Its amount is preferably in the range of from 0.1 to 5% by weight, and more preferably from 0.1 to 3% by weight with respect to the whole of the ink composition.

### (High Molecular Compound)

For the purpose of adjusting film physical properties, various high molecular compounds can be added in the ink composition of the invention. Examples of the high molecular compound which can be used include acrylic polymers, polyvinyl butyral resins, polyurethane resins, polyamide resins, polyester resins, epoxy resins, phenol resins, polycarbonate resins, polyvinyl butyral resins, polyvinyl formal resins, shellac, vinyl based resins, acrylic resins, rubber based resins, waxes, and other natural resins. Such a high molecular compound may be used in combination with two or more kinds thereof. Of these, vinyl based copolymers obtainable from copolymerization of an acrylic monomer are preferable. In addition, with respect to the copolymerization composition of a high molecular binding material, copolymers containing, as a structural unit, a “carboxyl group-containing monomer”, an “alkyl methacrylate” or an “alkyl acrylate” are also preferably used.

### (Surfactant)

A surfactant may also be added in the ink composition of the invention.

As the surfactant, there are enumerated surfactants as described in JP-A-62-173463 and JP-A-62-183457. Examples thereof include anionic surfactants such as dialkylsulfosuccinic acid salts, alkylnaphthalenesulfonic acid salts, and fatty acid salts; nonionic surfactants such as polyoxyethylene alkyl ethers, polyoxyethylene alkylaryl ethers, acetylene glycols, and polyoxyethylene-polyoxypropylene block copolymers; and cationic surfactants such as alkylamine salts and quaternary ammonium salts. Incidentally, organic fluoro compounds may be used in place of the foregoing surfactants. It is preferable that the organic fluoro compound is hydrophobic. Examples of the organic fluoro compound include fluorine based surfactants, oily fluorine based compounds (for example, fluorine oils), and solid fluorine compound resins (for example, tetrafluoroethylene resins). Also, there are enumerated organic fluoro compounds as described in JP-B-57-9053 (columns 8 to 17) and JP-A-62-135826.

Besides, it is possible to contain, for example, a leveling additive, a matting agent, a wax for adjusting film physical properties, and a tackifier for improving adhesion to a medium to be recorded such as polyolefins and PET, which does not hinder the polymerization, as the need arises.

Concretely, the tackifier includes high molecular adhesive polymers as described on pages 5 to 6 of JP-A-2001-49200 (for example, copolymers made of an ester between (meth)acrylic acid and an alcohol containing an alkyl group having from 1 to 20 carbon atoms, an ester between (meth)acrylic acid and an alicyclic alcohol having from 3 to 14 carbon atoms, or an ester between (meth)acrylic acid and an aromatic alcohol having from 6 to 14 carbon atoms); and low molecular tackiness-imparting resins containing a polymerizable unsaturated bond.

### (Preferred Physical Properties of Ink Composition)

Taking into account the injection properties, an ink viscosity of the ink composition of the invention is preferably from 7 to 30 mPa·s, and more preferably from 7 to 20 mPa·s at the temperature at the time of injection. Furthermore, it is preferable that a composition ratio is properly adjusted and determined such that the ink viscosity falls within the foregoing range. Incidentally, the ink viscosity at 25 to 30° C. is from 35 to 500 mPa·s, and preferably from 35 to 200 mPa·s. By setting up the viscosity at room temperature in a high level, even in the case of using a porous medium to be recorded, it is possible to prevent penetration of the ink into the medium to be recorded, to reduce uncured monomers and to reduce odors. In addition, it is possible to control oozing of dots at the time of impacting ink droplets, resulting in an improvement of the image quality. When the ink viscosity at 25 to 30° C. is less than 35 mPa·s, the effect for preventing oozing becomes small. On the other hand, when it exceeds 500 mPa·s, there is caused a problem in delivery of the ink liquid.

A surface tension of the ink composition of the invention is preferably from 20 to 40 mN/m, and more preferably from 25 to 35 mN/m. In the case of achieving recording on various media to be recorded such as polyolefins, PET, coated papers, and non-coated papers, the surface tension of the ink composition of the invention is preferably 20 mN/m or more from the viewpoints of oozing and penetration, and it is preferably not more than 40 mN/m in view of wetting properties.

The thus adjusted ink composition of the invention is suitably used as an ink for inkjet recording. In the case of using the ink composition of the invention as an ink for inkjet recording, the ink composition is injected onto a medium to be recorded by an inkjet printer, and thereafter, the injected ink composition is irradiated with active energy and cured, thereby achieving recording.

Since a printed matter as obtained from this ink has an image area which has been cured by irradiation with active energy such as ultraviolet rays and has excellent strength, it can be used for various utilities such as the formation of an ink receiving layer (image area) of a lithographic printing plate other than the formation of an image by the ink.

### (Radical Polymerization Based Ink Composition)

The radical polymerization based ink composition contains a radical polymerizable compound and a polymerization initiator. If desired, the radical polymerization based ink composition may further contain a sensitizing dye, a coloring material, and so on.

The respective constitutional components to be used in the radical polymerization based ink composition which can be used will be hereunder described in order.

### (Radical Polymerizable Compound)

The radical polymerizable compound includes, for example, a compound containing an addition polymerizable ethylenically unsaturated bond as enumerated below.

### (Compound Containing an Addition Polymerizable Ethylenically Unsaturated Bond)

Examples of the compound containing an addition polymerizable ethylenically unsaturated bond which can be used in the ink composition of the invention include esters between an unsaturated carboxylic acid (for example, acrylic acid, methacrylic acid, itaconic acid, crotonic acid, isocrotonic acid, and maleic acid) and an aliphatic polyhydric alcohol compound and amides between the foregoing unsaturated carboxylic acid an aliphatic polyhydric amine compound.

Specific examples of monomers of an ester between an aliphatic polyhydric alcohol compound and an unsaturated carboxylic acid are as follows. That is, examples of acrylic esters include ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl)isocyanurate, and polyester acrylate oligomers.

Examples of methacrylic esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(acryloxyethoxy)phenyl]dimethylmethane. Examples of itaconic esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic esters include ethylene glycol di-crotonate, tetramethylene glycol dicrotonate, pentaerythritol dicrotonate, and sorbitol tetradicrotonate. Examples of isocrotonic esters include ethylene glycol diisocrotonate, pentaerythritol diisocrotonate, and sorbitol tetraisocrotonate. Examples of maleic esters include ethylene glycol dimaleate, triethylene glycol dimaleate, pentaerythritol dimaleate, and sorbitol tetramaleate. In addition, mixtures of the foregoing ester monomers can be enumerated. Also, specific examples of monomers between an aliphatic polyhydric amine compound and an unsaturated carboxylic acid include methylene bisacrylamide, methylene bismethacrylamide, 1,6-hexamethylene bisacrylamide, 1,6-hexamethylene bismethacrylamide, diethylene triamine trisacrylamide, xylylene bisacrylamide, and xylylene bismethacrylamide.

As other examples, there are enumerated vinyl urethane compounds containing two or more polymerizable vinyl groups in one molecule thereof in which a hydroxyl group-containing vinyl monomer represented by the general formula (A): CH₂═C(R)COOCH₂CH(R′)OH (wherein R and R′ each represents H or CH₃) is added to a polyisocyanate compound containing two or more isocyanate groups in one molecule thereof, as described in JP-B-48-41708.

Furthermore, there can be enumerated functional acrylates and methacrylates such as urethane acrylates as described in JP-A-51-37193; polyester acrylates as described in JP-A-48-64183, JP-B-49-43191, and JP-B-52-30490; and epoxy acrylates resulting from a reaction between an epoxy resin and (meth)acrylic acid. In addition, compounds presented as photo curable monomers and oligomers in Journal of the Adhesion Society of Japan, Vol. 20, No. 7, pp. 300-308 (1984) can be used. In the invention, these monomers can be used in a chemical morphology such as prepolymers, namely dimers and trimers, oligomers, and mixtures or copolymers thereof.

The amount of use of the radical polymerizable compound is usually from 1 to 99.99%, preferably from 5 to 90.0%, and more preferably from 10 to 70% (the term “%” means % by weight) with respect to the whole of components of the ink composition.

### (Photopolymerization Initiator)

Next, the photopolymerization initiator which is used in the radical polymerization based ink composition of the invention will be hereunder described.

The photopolymerization initiator in the invention is a compound capable of generating a chemical change via an action of light or a mutual action with an electron excited state of a sensitizing dye to form at least one of radicals, acids and bases.

Preferred examples of the photopolymerization initiator include (a) aromatic ketones, (b) aromatic onium salt compounds, (c) organic peroxides, (d) hexaacryl biimidazole compounds, (e) keto oxime ester compounds, (f) borate compounds, (g) azinium compounds, (h) metallocene compounds, (i) active ester compounds, and (j) compounds containing a carbon-halogen bond.

### (Sensitizing Dye)

In the invention, for the purpose of improving the sensitivity of the photopolymerization initiator, a sensitizing dye maybe added. As the preferred sensitizing dye, there can be enumerated the following compounds which have an absorption wavelength in a region of from 350 nm to 450 nm.

That is, examples of the sensitizing dye include polynuclear aromatic compounds (for example, pyrene, perylene, and triphenylene), xanthenes (for example, Fluororescein, Eosine, Erythrocin, Rhodamine B, and Rose Bengale), cyanines (for example, Thiacarbocyanine and Oxacarbocyanine), merocyanines (for example, merocyanine and carbomerocyanine), thiazines (for example, Thionine, Methylene Blue, and Toluidine Blue), acridines (for example Acridine Orange, chloroflavin, and acriflavin), anthraquinones (for example, anthraquinone), squaryliums (for example, squarylium), and coumarins (for example, 7-diethylamino-4-methylcoumarin).

### (Cosensitizer)

In addition, known compounds having actions such as an action to further improve the sensitivity and an action to control the polymerization inhibition due to oxygen may be added as a cosensitizer in the ink of the invention.

Examples of such a cosensitizer include compounds as described in M. R. Sander, et al., Journal of Polymer Society, Vol. 10, p. 3173 (1972), JP-B-44-20189, JP-A-51-82102, JP-A-52-134692, JP-A-59-138205, JP-A-60-84305, JP-A-62-18537, JP-A-64-33104, and Research Disclosure, No. 33825. Specific examples thereof include triethanolamine, ethyl p-dimethylaminobenzoate, p-formyldimethylaniline, and p-methylthiodimethylaniline.

As other examples, there are enumerated thiols and sulfides, for example, thiol compounds as described in JP-A-53-702, JP-B-55-500806, and JP-A-5-142772 and disulfide compounds as described in JP-A-56-75643. Specific examples thereof include 2-methylmercaptobenzothiazole, 2-mercaptobenzoxazole, 2-methylmercaptobenzimidazole, 2-mercapto-4 (3H)-quinazoline, and β-mercaptonaphthalene.

As other examples, there are enumerated amino acid compounds (for example, N-phenylglycine), organometallic compounds as described in JP-B-48-42965 (for example, tributyl tin acetate), hydrogen donators as described in JP-B-55-34414, sulfur compounds as described in JP-A-6-308727 (for example, triathiane), phosphorus compounds as described in JP-A-6-250387 (for example, diethyl phosphite), and Si—H and Ge—H compounds as described in Japanese Patent Application No. 6-191605.

Furthermore, from the viewpoint of enhancing the preservability, it is preferred to add a polymerization inhibitor in an amount of from 200 to 20,000 ppm. It is preferable that the ink for inkjet recording of the invention is made to have a low viscosity by heating at a temperature in the range of from 40 to 80° C. and then injected. For the purpose of preventing head plugging by thermal polymerization from occurring, it is preferred to add a polymerization inhibitor. Examples of the polymerization inhibitor include hydroquinone, benzoquinone, p-methoxyphenol, TEMPO, TEMPOL, and cupferron Al.

### (Others)

Besides, known compounds can be used as the need arises. For example, surfactants, leveling additives, matting agents, and polyester based resins, polyurethane based resins, vinyl based resins, acrylic resins, rubber based resins, and waxes for the purpose of adjusting film physical properties can be properly selected and used. Furthermore, for the purpose of improving adhesion to a medium to be recorded such as polyolefins and PET, it is also preferred to contain a tackifier which does not inhibit the polymerization. Concretely, the tackifier includes high molecular adhesive polymers as described on pages 5 to 6 of JP-A-2001-49200 (for example, copolymers made of an ester between (meth)acrylic acid and an alcohol containing an alkyl group having from 1 to 20 carbon atoms, an ester between (meth)acrylic acid and an alicyclic alcohol having from 3 to 14 carbon atoms, or an ester between (meth)acrylic acid and an aromatic alcohol having from 6 to 14 carbon atoms); and low molecular tackiness-imparting resins containing a polymerizable unsaturated bond.

Furthermore, for the purpose of improving adhesion to the medium to be recorded, it is also effective to add an extremely trace amount of an organic solvent. In this case, it is effective to add the organic solvent in an amount within the range where problems in solvent resistance and VOC are not caused. Its amount is preferably in the range of from 0.1 to 5% by weight, and more preferably from 0.1 to 3% by weight with respect to the whole of the ink composition.

Furthermore, as a measure for preventing a lowering of the sensitivity due to a light shielding effect of the ink coloring material, it is also one of the preferred embodiments to form a radical/cation hybrid type curing ink by combining a cationic polymerizable monomer having a long life as a polymerization initiator and a polymerization initiator.

### (Aqueous Ink Composition)

An aqueous ink composition contains a polymerizable compound and a water-soluble photopolymerization initiator capable of generating a radical by the action of active energy. If desired, the aqueous ink composition may further contain a coloring material and the like.

### (Polymerizable Compound)

As the polymerizable compound which is contained in the aqueous ink composition of the invention, polymerizable compounds which are contained in known aqueous ink compositions can be used.

In order to optimize a formulation while taking into account end user characteristics such as curing rate, adhesion and flexibility, a reactive material can be added in the aqueous ink composition. As such a reactive material, for example, (meth)-acrylate (namely, acrylate and/or methacrylate) monomers and oligomers, epoxides, and oxetanes are useful.

Examples of the acrylate monomer include phenoxyethyl acrylate, octyldecyl acrylate, tetrahydrofurfuryl acrylate, isobornyl acrylate, hexanediol diacrylate, trimethylolpropane triacrylate, pentaerythritol triacrylate, polyethylene glycol diacrylates (for example, tetraethylene glycol diacrylate), dipropylene glycol diacrylate, tri(propylene glycol)triacrylate, neopentyl glycol diacrylate, bis(pentaerythritol)hexaacrylate, acrylates of an ethoxylated or propoxylated glycol and a polyol (for example, propoxylated neopentyl glycol diacrylate and ethoxylated trimethylolpropane triacrylate), and mixtures thereof.

Examples of the acrylate oligomer include ethoxylated polyethylene glycol, ethoxylated trimethylolpropane acrylate, polyether acrylate and ethoxylated products thereof, and urethane acrylate oligomers.

Examples of the methacrylate include hexanediol dimeth-acrylate, trimethylolpropane trimethacrylate, triethylene glycol dimethacrylate, diethylene glycol dimethacrylate, ethylene glycol dimethacrylate, 1,4-butanediol dimethacrylate, and mixtures thereof.

The amount of addition of the oligomer is preferably from 1 to 80% by weight, and more preferably from 1 to 10% by weight with respect to the whole weight of the ink composition.

### (Water-Soluble Photopolymerization Initiator Capable of Generating a Radical by the Action of Active Energy)

The polymerization initiator which can be used in the ink composition of the invention will be hereunder described. As one example, there are enumerated photopolymerization initiators having a wavelength of up to approximately 400 nm. Examples of such a photopolymerization initiator include photopolymerization initiators represented by the following general formulae, which are a substance having functionality in a long wavelength region, namely sensitivity so as to generate a radical by irradiation with ultraviolet rays (hereinafter abbreviated as “TX base”). In the invention, it is especially preferred to properly select and use a compound among these polymerization initiators.

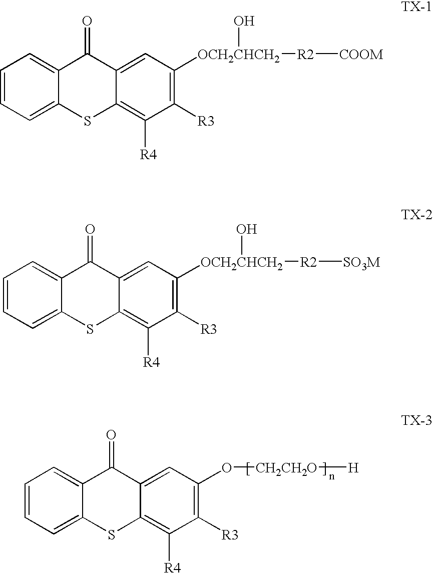

In the foregoing general formulae TX-1 to TX-3, R2 represents —(CH₂)ₓ— (wherein x represents 0 or 1), —O—(CH₂)_{y}— (wherein y represents 1 or 2), or a substituted or unsubstituted phenylene group. Furthermore, when R2 represents a phenylene group, at least one of hydrogen atoms in the benzene ring may be substituted with one or two or more groups or atoms selected from, for example, a carboxyl group or a salt thereof, a sulfonic acid or a salt thereof, a linear or branched alkyl group having from 1 to 4 carbon atoms, a halogen atom (for example, fluorine, chlorine, and bromine), an alkoxyl group having from 1 to 4 carbon atoms, and an aryloxy group such as phenoxy group. M represents a hydrogen atom or an alkali metal (for example, Li, Na, and K). In addition, R3 and R4 each independently represents a hydrogen atom or a substituted or unsubstituted alkyl group. Here, examples of the alkyl group include linear or branched alkyl groups having from approximately 1 to 10 carbon atoms, and especially from approximately 1 to 3 carbon atoms. Furthermore, examples of the substituent of the alkyl group include a halogen atom (for example, a fluorine atom, a chlorine atom, and a bromine atom), a hydroxyl group, and an alkoxyl group (for example, alkoxyl groups having from approximately 1 to 3 carbon atoms). Moreover, m represents an integer of from 1 to 10.

In addition, in the invention, water-soluble derivatives of a photopolymerization initiator, IRGACURE 2959 (a trade name, manufactured by Ciba Specialty Chemicals) represented by the following general formulae can be used. Concretely, a photopolymerization initiator composed of the following formulae IC-1 to IC-3 can be used.

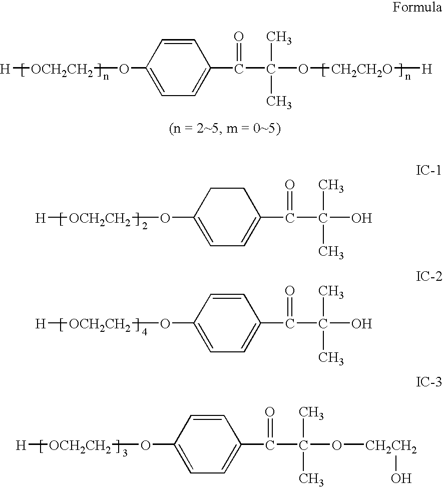

### (Formulation for Clear Ink)

By forming the foregoing water-soluble polymerizable compound into a transparent aqueous ink without containing the foregoing coloring material therein, it is possible to prepare clear ink. In particular, by preparing the ink so as to have inkjet recording characteristics, a water-soluble curing type clear ink for inkjet recording is obtained. When such an ink is used, since it does not contain a coloring material therein, a clear film can be obtained. Examples of the utilization of the coloring material-free clear ink include use for undercoating for the purpose of imparting adaptability to image printing to a material to be recorded and use for overcoating for the purposes of surface protection of an image as formed by a usual ink and decoration and gloss impartation. In response to these uses, it is also possible to disperse a colorless pigment or a fine particle not for the purpose of coloration, and the like. By adding such substances, it is possible to improve various characteristics such as image quality, fastness and processability (for example, handling properties) of a printed matter.

With respect to the formulation condition in applying such a clear ink, it is preferred to prepare the ink so as to contain from 10 to 85% of the water-soluble polymerizable compound as the major component of the ink and from 1 to 10 parts by weight, based on 100 parts by weight of the water-soluble polymerizable compound, of the photopolymerization initiator (for example, an ultraviolet ray polymerization catalyst), with the photopolymerization initiator being contained in an amount of at least 0.5 parts based on 100 parts of the ink.

### (Material Construction in Coloring Material-Containing Ink)

In the case of using the foregoing water-soluble polymerizable compound for a coloring material-containing ink, it is preferred to adjust the concentrations of the polymerization initiator and the polymerizable substance in the ink adaptive to the absorption characteristics of the coloring material which has been contained. As described previously, with respect to the blending amount, the amount of water or the solvent is made to fall within the range of from 40% to 90%, and preferably from 60% to 75% on the weight basis. In addition, the content of the polymerizable compound in the ink is in the range of from 1% to 30%, and preferably from 5% to 20% on the weight basis with respect to the whole amount of the ink. The amount of the polymerization initiator relies upon the content of the polymerizable compound and is generally in the range of from 0.1 to 7%, and preferably from 0.3 to 5% on the weight basis with respect to the whole amount of the ink.

In the case where a pigment is used as the coloring material of the ink, the concentration of the pure pigment fraction in the ink is generally in the range of from 0.3% by weight to 10% by weight with respect to the whole amount of the ink. The coloring power of the pigment relies upon the dispersed state of the pigment particle. The range of from about 0.3 to 1% is the range where the ink is used as an ink of a pale color. When the concentration exceeds this range, a concentration at which the ink is used for general coloration of colors is given.

The present application claims foreign priority based on Japanese Patent Application (JP2006-094696) filed March 30 of 2006, the contents of which is incorporated herein by reference.

What is claimed is:

1. A method of cutting a recording medium for an ink jet device, the ink jet device comprising:
a recording medium conveying unit that conveys a recording medium; and
a full-line ink jet head that has substantially the same length as the width of the recording medium, and that ejects an ink toward the recording medium conveyed by the recording medium conveying unit according to image signal to effect recording,
which comprises:
making a mark indicating the longitudinal position of the recording medium from the end head of the full-line ink jet head on the edge of the recording medium; and
cutting the recording medium subjected to recording using the marking.

2. A post-processing device for a recording medium, the post-processing device comprising:
an ink jet recording device comprising;
a recording medium conveying unit that conveys a recording medium; and
a full-line ink jet head that has substantially the same length as the width of the recording medium and that ejects an ink toward the recording medium conveyed by the recording medium conveying unit according to image signal to effect recording;
a reading unit that is disposed downstream of the ink jet device along the direction of conveyance of the recording medium, and that reads data recorded on the recording medium by the full-line ink jet head; and
a post-processing device that is disposed downstream of the reading unit along the direction of conveyance of the recording medium, and that post-processes the recording medium subjected to recording according to data read by the reading unit,
wherein
a mark indicating the longitudinal position of the recording medium is regularly made on the edge of the recording medium from the end head of the full-line ink jet head,
the reading unit reads the mark and sends result of reading the mark to the post-processing device, and
the post-processing device post-processes the recording medium subjected to recording according to positional data read by the reading unit.

3. The post-processing device for recording medium as claimed in claim 2, further comprising:
an active energy radiating device that is provided downstream of the full-line ink jet head along the direction of conveyance of the recording medium, and that cures the active energy-curable ink ejected on the recording medium
wherein
the ink is an active energy-curable ink, and
the recording medium is a web-shaped recording medium.
The post-processing device for recording medium as claimed in claim 3, wherein the web-shaped recording medium comprises an adhesive-paper, the adhesive paper comprising: a base material; and a release paper peelably provided on the base material.

5. The post-processing device for recording medium as claimed in claim 4, further comprising:
a cylinder that makes rocking and rotation; and
a punching blade that is attached to many sides of the cylinder and that cuts the release paper of the adhesive paper into a label according to data read by the reading unit.

6. The post-processing device for recording medium as claimed in claim 4, further comprising:
a stamper that is disposed upward of the adhesive paper during waiting, and that descends toward the adhesive paper during transfer; and
a seat unit on which a foil is provided, the seat unit being conveyed between the adhesive paper and the stamper,
wherein
the stamper presses the seat unit on the adhesive paper to transfer the foil onto one side of the adhesive paper.
